(19) United States
(12) Patent Application Publication
(10) Pub. No.: US 2011/0001317 A1
(43) Pub. Date: Jan. 6, 2011

(54) Changeable Connection Assembly for a Closed Suction Tube

(76) Inventor: Ti-Li Chang, Houli Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/496,760

(22) Filed: Jul. 2, 2009

(51) Int. Cl. F16L 37/05

(52) U.S. Cl. 285/148.2

(57) ABSTRACT

A connection assembly has a body, a connecting tube and a sealing base. The body is hollow and has a connection portion. The connection portion has a connection base having a front face and two engaging channels. The engaging channels are defined in the front face and face to each other. The connecting end with a suction tube is detachably attached to the front face of the connection base, communicates with the connection portion and has a connection plate. The connection plate held slidably in the engaging channels in the connection base. The sealing base is mounted detachably on the connection portion and has a sealing face and a guiding channel. The sealing face is flush with the front face of the connection base. The guiding channel is defined around the sealing face and communicates with the engaging channels in the connection base.

### BACKGROUND OF THE INVENTION

1. Field of the Invention

The present invention relates to a connection assembly, and more particularly to a changeable connection assembly for a closed suction tube.

2. Description of Related Art

A closed suction tube is used to draw secretion from a patient with a drawing force provided by a hospital vacuum source. Furthermore, the closed suction tube is used to perform the secretion suction on patient while providing ventilation simultaneously. Consequently, this can reduce bad influences to the vital sign of the patient.

However, the conventional connection assembly for a changeable closed suction tube does not have any sealing effect to a used closed suction tube, so secretion mounted on the closed suction tube may spread out thereof. Therefore, medial personnel easily contact with and are inflected by the secretion, and this easily causes cross inflection between patients and medial personnel in a hospital.

In addition, the conventional connection assembly is connected to a closed suction tube in a thread manner, so to connect and disconnect the closed suction tube to/from the conventional connector assembly is inconvenient.

To overcome the shortcomings, the present invention tends to provide a connection assembly to mitigate or obviate the aforementioned problems.

### SUMMARY OF THE INVENTION

The main objective of the invention is to provide a connection assembly for a closed suction tube and that is convenient in changing a used closed suction tube. The connection assembly has a body, a connecting end and a sealing base. The body is hollow and has a connection portion. The connection portion is hollow, is formed on the body and has a connection base. The connection base is formed on the connection portion and has a front face and two engaging channels. The front face has a top and a bottom. The engaging channels are defined respectively in the top and the bottom of the front face of the connection base and face to each other. The connecting end is detachably attached to the front face of the connection base, communicates with the connection portion and has a connection plate. The connection plate has two edges respectively held slidably in the engaging channels in the connection base. The sealing base is mounted detachably on the connection portion and has a sealing face, a guiding channel and a holding notch. The sealing face is flush with the front face of the connection base. The guiding channel is defined around the sealing face and communicates with the engaging channels in the connection base. The holding notch is defined in the sealing base and is mounted around and holding the connection portion.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a connection assembly for a closed suction tube in accordance with the present invention;

FIG. 2 is an exploded perspective view of the connection assembly in FIG. 1;

FIG. 3 is an exploded perspective view of the body and the connecting tube of the connection assembly in FIG. 1;

FIG. 4 is a cross sectional top view of the connection assembly in FIG. 1;

FIG. 5 is an operational cross sectional top view of the connection assembly in FIG. 1 showing a used connecting tube being changed with an unused one;

FIG. 6 is a perspective view of a second embodiment of a connection assembly for a closed suction tube in accordance with the present invention;

FIG. 7 is a front view of the connection assembly in FIG. 6; and

FIG. 8 is an operational front view of the connection assembly in FIG. 6 showing a used connecting tube being changed with an unused one.

### DETAILED DESCRIPTION OF PREFERRED EMBODIMENT

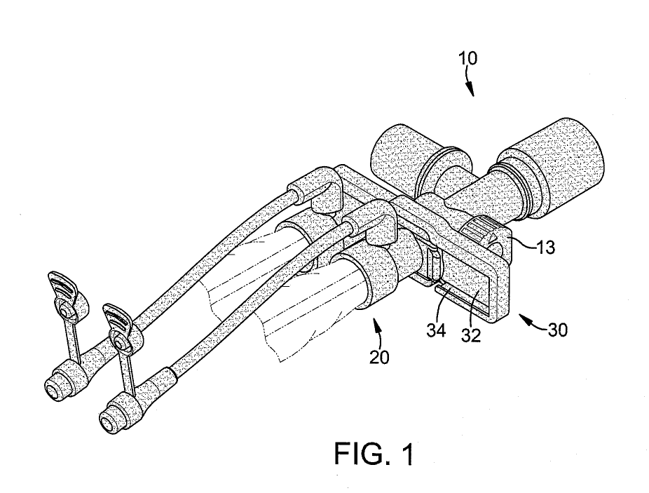

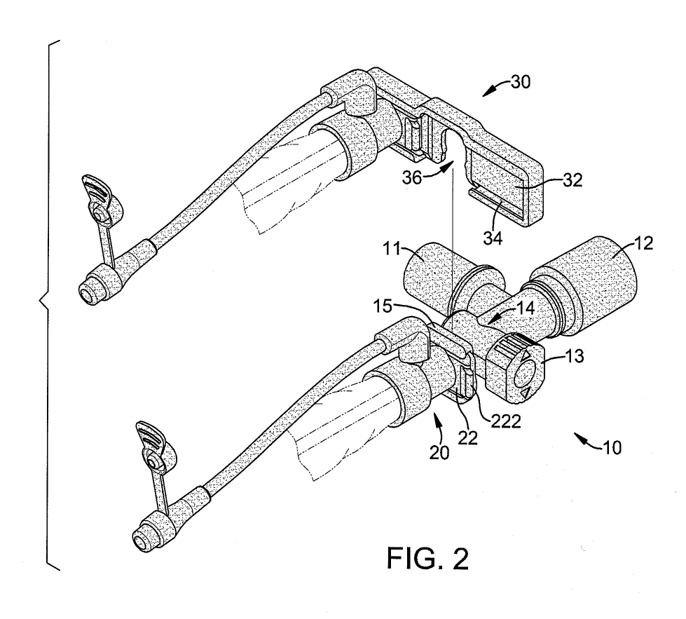

With reference to FIGS. 1 to 3, a connection assembly for a closed suction tube in accordance with the present invention comprises a body (10), a connecting end (20) and a sealing base (30). The body (10) is hollow and comprises a respiratory tube connector (11), an airway device connector (12), a connection portion (14) and an isolation valve (13). The respiratory tube connector (11) and the airway device connector (12) are formed on the body (10), communicate with each other and are connected respectively to a respiratory tube system and an airway device that is connected to a patient. The connection portion (14) is hollow and formed on the body (10), communicates with the respiratory tube connector (11) and the airway device connector (12) and has a connection base (15). The connection base (15) is formed on the connection portion (14) and comprises a front face and two engaging channels (152). The front face has a top, a bottom and an opening (142). The opening (142) is defined through the front face and communicates with the connection portion (14). The engaging channels (152) are defined respectively in the top and the bottom of the front face of the connection base (15) and face to each other. The isolation valve (13) is mounted on the body (10) to turn on or off a communication between the connection portion (14) and the connectors (11,12).

The connecting end (20) with a suction tube, is detachably attached to the front face of the connection base (15), communicates with the connection portion (14) via the opening (142) and comprises a connection plate (22). The connection plate (22) has two edges, a contacting face, an annular groove, an O-ring (24) and a holding assembly. The edges are respectively held slidably in the engaging channels (152) in the connection base (15). The contacting face faces to and abuts with the front face of the connection base (15) when the connecting end (20) is connected to the connection base (15). The contacting face has an opening defined through the contacting face and aligning and communicating with the opening (142) in the connection base (15) when the connecting end (20) is connected to the connection base (15). The annular groove is defined in and around the opening in the contacting face. The O-ring (24) is mounted in the annular groove, abuts against the front face of the connection base (15) and is mounted around the opening (142) in the connection base (15). With the arrangement of the O-ring (24), a sealing effect is provided to the communication between the connection portion (14) and the connecting end (20) to prevent the leakage of secretion drawn out from a patient.

The holding assembly is formed on the connection plate (22) and engages the connection base (15) on the body (10) to securely hold the connecting end (20) on the connection base (15). In the first embodiment, the holding assembly comprises two resilient holding arms (222) formed respectively on two sides of the connection plate (22) and abutting respectively with two sides of the connection base (15). With the abutment between the resilient holding arms (222) with the sides of the connection base (15), the connection plate (22) is kept from sliding relative to the engaging channels (152) so that the connecting end (20) will not be detached from the connection base (15) unintentionally.

The sealing base (30) is mounted detachably on the connection portion (14) and comprises a sealing face (32), a guiding channel (34) and a holding notch (36). The sealing face (32) is flush with the front face of the connection base (15) when the sealing base (30) is mounted on the connection portion (14). The guiding channel (34) is defined around the sealing face (32) and communicates with the engaging channels (152) in the connection base (15). The holding notch (36) is defined in the sealing base (30) and is mounted around and holds the connection portion (14) to connect the sealing base (30) onto the body (10). The holding notch (36) is defined in a middle portion of the sealing base (30) to formed two sealing zones on the sealing face (32) respectively at two sides of the holding notch (36). In practice, the sealing base (30) may further have a connecting end (20) mounted slidably on one of the sealing zones on the sealing face (32).

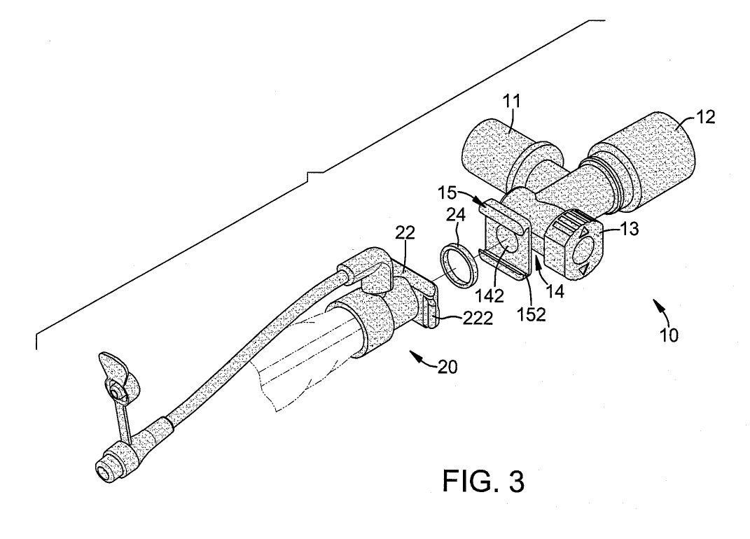

In use, with reference to FIG. 3, the body (10) is connected to a respiratory tube system and an airway device with the respiratory tube connector (11) and the airway device connector (12), and the connecting end (20) is connected to the suction tube. The connecting end (20) is connected to the connection portion (14) of the body (10) with the edges of the connection plate (22) being held respectively in the engaging channels (152) in the connection base (15). Accordingly, secretion, such as phlegm can be drawn out from a patient via the airway device, the body (10), the connecting end (20) and the closed suction tube with drawing force provided by a hospital vacuum source and a suction control valve in the end of tube.

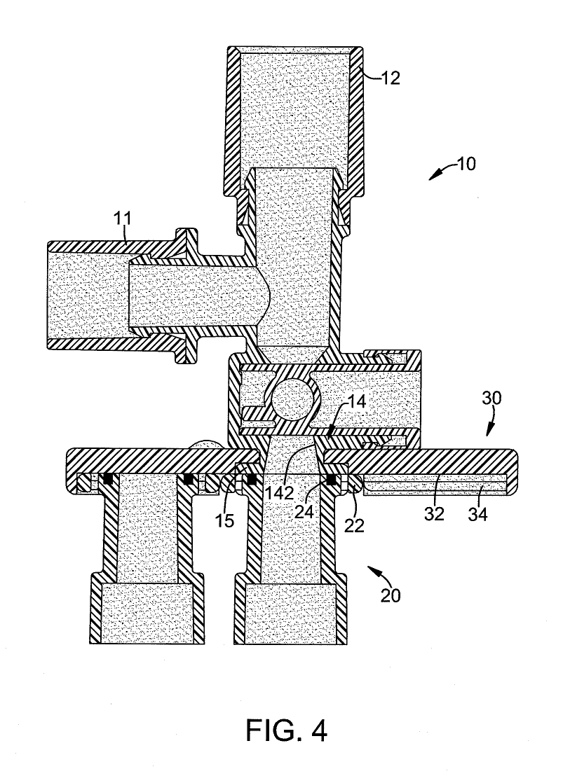

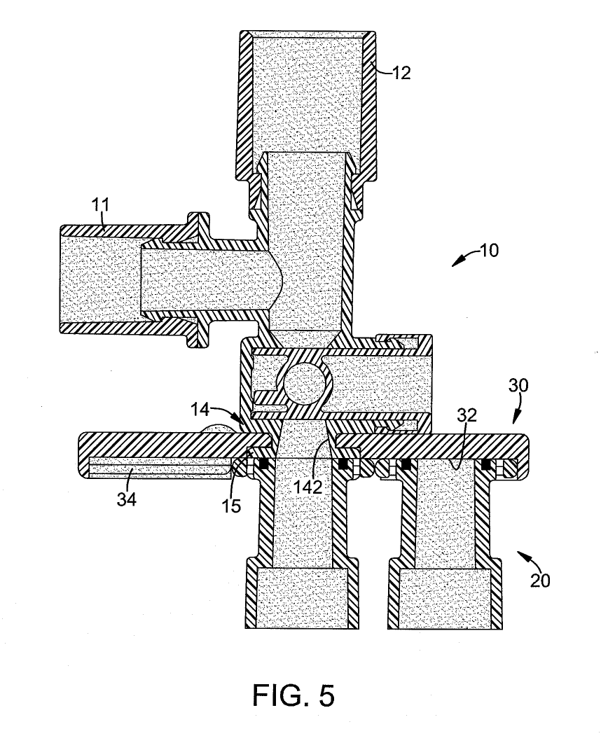

To change a used suction tube, with reference to FIGS. 4 and 5, the isolation valve (13) is turned off firstly. The sealing base (30) is then attached to the connection portion (14) on the body (10) to make the sealing face (32) being flush with the front face of the connection base (15) and the guiding channel (34) aligning and communicating with the engaging channels (152). At this time, the sealing face (32) of the sealing base (30) will push against the resilient holding arms (222) on the connection plate (22) to disengage from the sides of the connection base (15). Consequently, the connecting end (20) that is connected to the used suction tube can be moved away from the connection base (15) and to one of the sealing zones along the engaging channels (152) and the guiding channel (34). The sealing base (30) is then detached from the connection portion (14), and the used connecting end (20) and the used suction tube can be disconnected from the body (10). With the sealing face (32) on the sealing base (30), the connecting tube (20) can be well sealed to prevent the secretion in the closed suction tube from leaking therefrom. Therefore, medical personnel can be kept from contacting with and being inflected by the secretion, such that cross inflection between patients and medical personnel can be efficiently avoided.

If a new connecting end (20) with an unused suction tube is mounted previously on the sealing base (30), the new and unused connecting tube (20) can be moved toward and engaged the connection base (15) and pushes the used connecting tube (20) to move away from the connection base (15). After the sealing base (30) being detached from the body (10), new and unused connecting end (20) and suction tube are connected to the body (10). Accordingly, the process for replacing a new closed suction tube is easy and convenient.

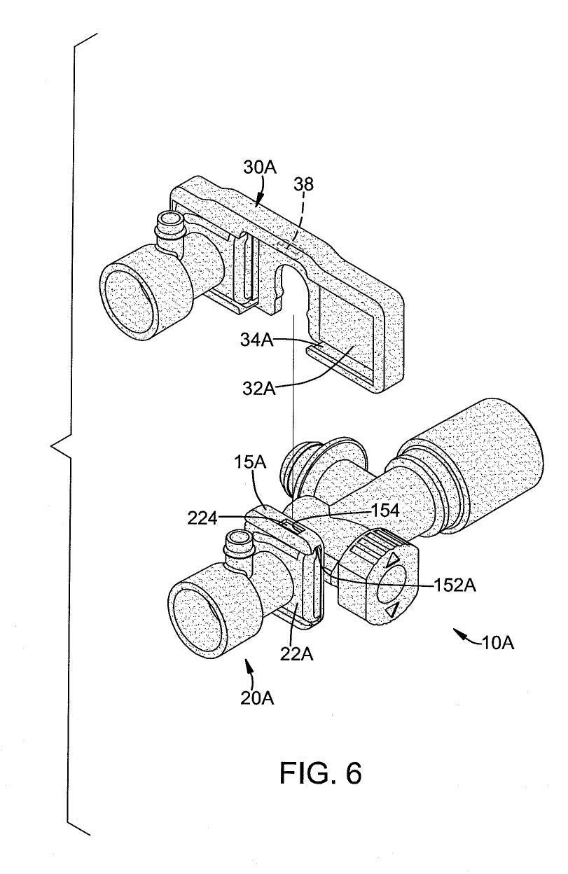

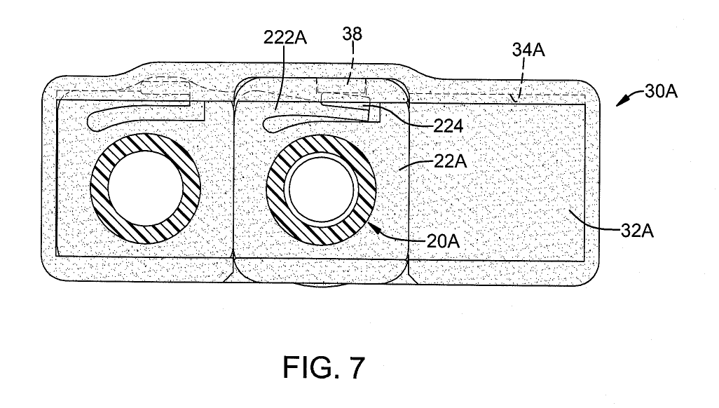

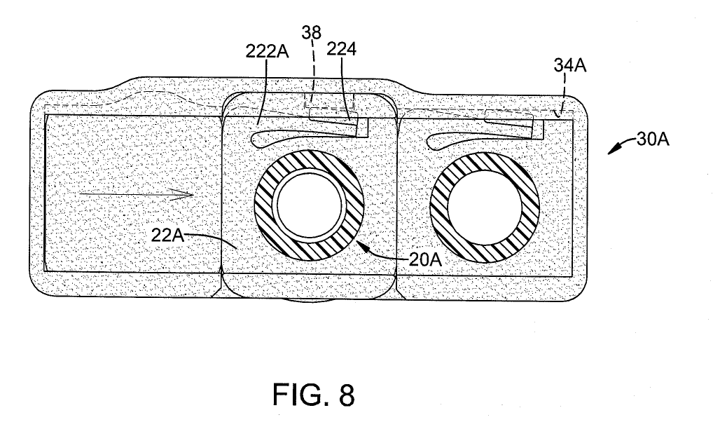

With reference to FIGS. 6 to 8, in a second embodiment of a connection assembly in accordance with the present invention, the holding assembly on the connection plate (22A) comprises a resilient holding arm (222A) formed on one of the edges of the connection plate (22A) that engages one of the engaging channels (152A) in the connection base (15A). The resilient holding arm (222A) has an engaging block (224) formed on the resilient holding arm (222A). The connection base (15A) further has an engaging hole (154) defined in the connection base (15A) and engaging the engaging block (224) on the resilient holding arm (222A). With the engagement between the engaging block (224) on the resilient holding arm (222A) and the engaging hole (154), the connecting end (20A) will not be disconnected from the connection base (15A) unintentionally. Furthermore, the sealing base (30A) further has a pushing block (38) formed in the guiding channel (34A). When the sealing base (30A) is attached to the body (10A), the pushing block (38) is inserted into the engaging hole (154) and disengages the engaging block (224) on the resilient holding arm (222A) from the engaging hole (154). Accordingly, the connection plate (22A) is allowed to slide along the engaging channels (152A) and into the guiding channel (34A) and be sealed by the sealing face (32A) on the sealing base (30A).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connection assembly for a closed suction tube comprising:
a body being hollow and comprising a connection portion being hollow, formed on the body and having a connection base formed on the connection portion and comprising
a front face having a top and a bottom; and
two engaging channels defined respectively in the top and the bottom of the front face of the connection base and facing to each other;
a connecting end adapted to connecting with suction tube and detachably attached to the front face of the connection base, communicating with the connection portion and comprising a connection plate having two edges respectively held slidably in the engaging channels in the connection base; and
a sealing base mounted detachably on the connection portion and having
a sealing face being flush with the front face of the connection base when the sealing base is attached to the connection portion;
a guiding channel defined around the sealing face and communicating with the engaging channels in the connection base; and
a holding notch defined in the sealing base and mounted around and holding the connection portion.

2. The connection assembly as claimed in claim 1, wherein
the connection plate on the connecting end has a holding assembly formed on the connection plate and engaging the connection base on the body.

3. The connection assembly as claimed in claim 2, wherein the holding assembly on the connection plate comprises two resilient holding arms formed respectively on two sides of the connection plate and abutting respectively with two sides of the connection base after the sealing base being detached from the connection portion of the body.

4. The connection assembly as claimed in claim 3, wherein the connection plate of the connecting end has a contacting face facing to and abutting with the front face of the connection base;
an annular groove defined in the contacting face; and
an O-ring mounted in the annular groove and abutting against the front face of the connection base.

5. The connection assembly as claimed in claim 4, wherein the holding notch is defined in a middle portion of the sealing base to formed two sealing zones on the sealing face respectively at two sides of the holding notch.

6. The connection assembly as claimed in claim 5, wherein the sealing base further has a connecting end mounted slidably on one of the sealing zones on the sealing face.

8. The connection assembly as claimed in claim 2, wherein
the holding assembly on the connection plate comprises a resilient holding arm formed on one of the edges of the connection plate that engages one of the engaging channels in the connection base and having an engaging block formed on the resilient holding arm; and
the connection base further has an engaging hole defined in the connection base and engaging the engaging block on the resilient holding arm.

9. The connection assembly as claimed in claim 8, wherein the sealing base further has a pushing block formed in the guiding channel and inserting into the engaging hole to disengage the engaging block on the resilient holding arm from the engaging hole when the sealing base is attached to the connection portion of the body.

10. The connection assembly as claimed in claim 9, wherein the connection plate of the connecting end has
a contacting face facing to and abutting with the front face of the connection base;
an annular groove defined in the contacting face; and
an O-ring mounted in the annular groove and abutting against the front face of the connection base.

11. The connection assembly as claimed in claim 10, wherein the holding notch is defined in a middle portion of the sealing base to formed two sealing zones on the sealing face respectively at two sides of the holding notch.

12. The connection assembly as claimed in claim 11, wherein the sealing base further has a connecting end mounted slidably on one of the sealing zones on the sealing face.

13. The connection assembly as claimed in claim 1, wherein the connection plate of the connecting end has
a contacting face facing to and abutting with the front face of the connection base;
an annular groove defined in the contacting face; and
an O-ring mounted in the annular groove and abutting against the front face of the connection base.

14. The connection assembly as claimed in claim 11, wherein the holding notch is defined in a middle portion of the sealing base to formed two sealing zones on the sealing face respectively at two sides of the holding notch.

15. The connection assembly as claimed in claim 14, wherein the sealing base further has a connecting end mounted slidably on one of the sealing zones on the sealing face.
